(19) United States
(12) Patent Application Publication
(10) Pub. No.: US 2006/0174992 A1
(43) Pub. Date: Aug. 10, 2006

(54) Web stabilization for accurate pattern registration

(76) Inventors: Randolph C. Brost, Albuquerque, NM (US); Robert J. Deprez, Avon, NY (US); Robert L. Walton, Fairport, NY (US)

Correspondence Address: Pamela R. Crocker;Patent Legal Staff, Eastman Kodak Company, 343 State Street, Rochester, NY, 14650-2201, US

(21) Appl. No.: 11/053,802

(22) Filed: Feb. 9, 2005

(51) Int. Cl. B32B 38/00; B32B 38/14; B32B 37/16; B32B 38/10; B32B 37/12

(52) U.S. Cl. 156/64; 156/247; 156/277

(57) ABSTRACT

A method for registering patterns on a web comprises attaching a backing material to a web and stabilizing the web; routing the web over one or more sets of rollers; applying a pattern to the web; and removing the backing material. Patterning can be applied at a set of rollers or between rollers along the path of the web. The backing material has indicia thereon for use in registration of the patterns applied to the web. Using the method, a steel backing material can be applied with an adhesive to a polyethylene terephthalate web material.

### FIELD OF THE INVENTION

The invention relates to a method and apparatus for registering multiple patterns on a web of material, and, more particularly, to a method for stabilizing the web for accurate pattern registration.

### BACKGROUND OF THE INVENTION

Several manufacturing processes require application of a pattern or patterns to web materials. Examples include printing, and the manufacture of electronic assemblies on flexible substrates. When multiple patterns are applied in sequence, proper alignment or registration must be achieved between patterns. Registration errors can cause misalignment between process steps or layers, as shown in FIGS. 1 and 2. In these figures, the “+” and “●” symbols represent patterns applied in different process steps. FIG. 1 shows correct registration, where all “+” and “●” marks are aligned. FIG. 2 shows registration error resulting from positional misalignment between the two process steps.

Registration precision is limited by manufacturing process hardware, and also by the dimensional stability of the web substrate. When the web material is dimensionally unstable, then no amount of precise position control will lead to correct registration. This is shown in FIG. 3 where the web has undergone a dimensional change between process steps. As a result, most points are not correctly aligned, even though points on the left side near the web centerline are correctly positioned.

Commonly used web materials such as polyethylene terephthalate (PET) exhibit poor dimensional stability relative to requirements, for display manufacture for example. They have a high coefficient of thermal expansion, experience hygroscopic expansion in humid environments, and can exhibit anisotropic shrink when exposed to moderately high temperatures. These material properties prevent high-precision registration using position-controlled web conveyance systems, leading instead to results such as those shown in FIG. 3. Nonetheless, PET is highly desirable for some final products because of its transparency, light weight, flexibility, durability, and toughness. A need therefore exists for a method for dimensionally stabilizing a PET web so that precisely registered multiple patterns can be applied.

### SUMMARY OF THE INVENTION

Briefly summarized, according to one aspect of the invention, a method for registering patterns on a web comprises attaching a backing material to a web and stabilizing the web; routing the web over rollers with the backing attached; applying a pattern to the web; and removing the backing material. The backing material is a dimensionally stable material and also dimensionally stabilizes the web while a pattern is applied but is removed for final use. Using a stabilizing backing material allows the use of favored web materials that are not dimensionally stable. Registration indicia on the backing material allows registration to be performed using the dimensionally stable backing material.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 illustrates multiple patterns on a web with correct registration;

FIG. 2 illustrates multiple patterns on a web with incorrect registration wherein the “+” and “●” patterns are not aligned atop one another;

FIG. 3 illustrates multiple patterns on a dimensionally unstable web with incorrect registration wherein some of the “+” and “●” patterns are not aligned atop one another;

FIG. 4 is a diagram illustrating the web conveyance path wherein patterning is applied using a deposition source; and

FIG. 5 is a diagram of a portion of a web with a backing material applied according to the present invention.

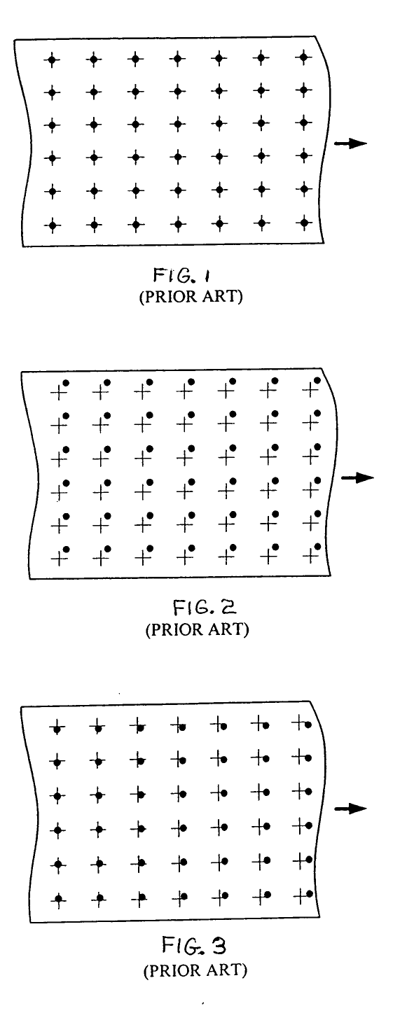

### DETAILED DESCRIPTION OF THE INVENTION

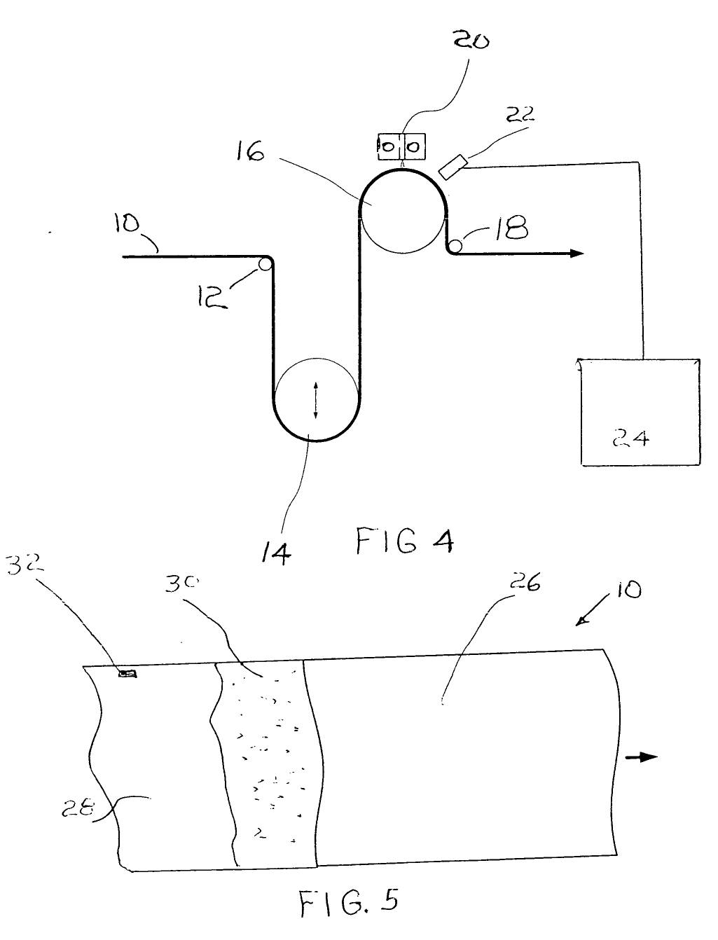

Referring to FIGS. 4-5, a web 10 passes first over an entrance idler roller 12, then a tension modulating roller 14, a stabilizing roller 16 and finally an exit idler roller 18. Tension modulating roller 14 effectively moves toward and from stabilizing roller 16 as indicated by the arrow to adjust web tension. Optionally, rollers 14 and 16 may be temperature controlled to maximize dimensional stability. Roller 16 stabilizes the web while the patterning process is applied by a deposition device, such as print head 20 or the like. Print head 20 preferably has fluid passages for temperature adjustment. A camera 22 is provided to measure current registration to provide an error signal that is fed back to a controller 24. The cameras are an example of a sensor for measuring current registration accuracy; other sensors with different operating modalities could be provided instead of, or in addition to the cameras. Other sensors, such as encoders and load cells, would naturally also be included in the system, but are not shown in the drawings. Accordingly, it is to be understood that FIG. 4 is just one illustration of how a web may be conveyed and processed—other conveyances and processes can be used.

Position is controlled, in the machine direction, by synchronizing the process drive roller, roller 14 and/or roller 16 with process execution. For example, if the process is an ink jet printing process, then the timing of ink ejection is coordinated with the web position as determined by the system sensors. In the cross direction, corrections are made by translating the process hardware back and forth in the cross direction. If this is not possible, then an alternative solution is to steer the web using a guider. Similarly, alternative schemes for adjusting position in the machine direction may be employed if the process is not controlled by electronic timing signals.

During operation, web 10 traverses a path over roller 16 where a pattern is applied by print head 20. Alternatively, patterns could be applied in the span between adjacent rollers along the web path. Camera system 22 checks the pattern applied and develops an error signal that is input to controller 24. The controller uses information from the error signal to initiate corrections to yield correct registration. Controller 24 can effect movement of roller 14 to adjust web tension. Also, controller 24 can adjust the temperature of roller 16 and print head 20. In addition, the controller can adjust other process hardware to correct registration.

Referring to FIG. 5, web 10 is preferably formed of a layer of polyethylene terephthalate (PET) web material 26 attached to a stable backing material, such as steel 28, with a layer of adhesive 30. Temporarily applying backing material 28 solves the problem of dimensional instability of the PET web material 26. The backing is preferably made of a dimensionally stable material, such as steel, and is attached to the web using an adhesive. The backing web thickness is large enough to ensure that the backing web will stretch the primary web as required to maintain dimensional stability. The backing is applied at the beginning of the manufacturing process, and kept in place throughout all process steps. A single pattern may be applied a single time or multiple times, or multiple patterns can be applied. Once the patterning steps have been completed, the backing web is removed.

Using backing web 28 provides the advantage that the dimensional stability maintained between process steps is the good stability of the backing web, rather than the poor stability of the primary web. An additional advantage is that the backing web protects the primary web surface from accidental scratches, blemishes, or other defects, leaving a pristine, high-quality surface once the backing web is removed.

Because the backing material is stable, reference or registration indicia 32 may be applied and used for pattern registration alone or in addition to the patterns themselves or in conjunction with the patterns themselves. Having such a reference feature on the backing material instead of on the web that is receiving the pattern has several advantages. One advantage is in having a reference mark that is ideally suited for being a positional reference, rather than making a special mark on the web material or using one of the applied images. A special mark translates to waste of web material. Using an applied image may not be ideal for positional measurement. A reference indicia on the backing material allows the use of a positional feature of a type that is different from the applied pattern (a magnetically encoded strip or laser etch, for instance). Also, it allows for registration of applied images that can not be easily measured as applied. The first applied pattern could be a nearly transparent sub-layer, or a layer that is transparent under the conditions used to apply the pattern, but not later during use.

As is evident from the foregoing description, certain aspects of the invention are not limited to the particular details of the examples illustrated, and it is therefore contemplated that other modifications and applications will occur to those skilled in the art. For example, when the backing is wider than the web, it is possible to use edge rollers or undercut face-side rollers to contact the backing web on the same side as the applied pattern on the product web without touching the product web. This allows longer and/or more complex processing paths. It also allows the use of pinch or nip rollers for driving the backing web more positively than merely wrapping it around a roller. It also allows for rollers on both sides of the backing web to provide stability normal to the plane of the web during processes that may otherwise cause instability, such as air impingement for instance.

There is also the ability to provide mechanical features, such as perforations or teeth, that can interface with pins, sprockets or gears to provide a mechanical coupling to a drive or positioning component to provide more positive speed or position control of the backing web, like movie film in a projector.

It is also apparent that the backing material can be destroyed or eliminated after its period of usefulness has ended. The product web does not have to be mechanically stripped from the backing web at the end of the process. For instance, if the product web is a very thin metal foil and the backing web or adhesive is a polymeric material that could be dissolved by exposure to a solvent, melted or vaporized by exposure to a solvent, ultraviolet light, or some other environment that would not damage the product web, then mechanical stripping is not necessary.

While the invention has been described with particular reference to the preferred embodiments, it will be understood by those skilled in the art that various changes may be made and equivalents may be substituted for elements of the preferred embodiments without departing from invention. For example, while the invention has been described with reference to a web of PET, other dimensionally unstable web materials could be used Also, backing materials other than steel or metal could be used advantageously.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 web
12 entrance idler roller
14 tension control roller
16 web stabilizing roller
18 exit idler roller
20 deposition source/print head
22 camera
24 controller
26 layer of PET
28 steel backing
30 adhesive
32 registration indicia

1. A method for registering patterns on a web, comprising the steps of:
attaching a backing material to a web and stabilizing the web;
routing the web using rollers;
applying patterns to the web; and
removing the backing material.

2. The method of claim 1 wherein the step of attaching the backing material includes the step of applying an adhesive to at least one of the web and backing material.

3. The method of claim 1 wherein the step of removing the backing material includes the steps of exposing the backing material to a destructive environment and destroying the backing material.

4. The method of claim 1 including the steps of:
measuring registration of the pattern;
providing an error signal; and
controlling web position using the error signal.

5. The method of claim 4 wherein the step of measuring registration includes detecting registration indicia on the backing material.

6. The method of claim 1 wherein the backing material is wider than the web.

7. The method of claim 1 wherein the backing material is metal.

8. The method of claim 1 wherein the backing material is steel.

9. The method of claim 1 wherein the web material is polyethylene terephthalate.

10. The method of claim 1 wherein patterns are applied at one of the rollers.

11. The method of claim 1 wherein patterns are applied between rollers.

12. The method of claim 11 wherein patterns are applied between adjacent rollers along the path of the web.
